(19) United States
(12) Patent Application Publication
(10) Pub. No.: US 2010/0025160 A1
(43) Pub. Date: Feb. 4, 2010

(54) Gravity Powered Rail, Road and Runway transportation systems

(76) Inventors: Rajaram BOJJI, Herndon, VA (US); Ananda Krishna Bojji, Herndon, VA (US)

Correspondence Address: Rajaram Bojji, 834 Spring Knoll Drive, Herndon, VA, 20170, US

(21) Appl. No.: 12/184,151

(22) Filed: Jul. 31, 2008

(51) Int. Cl. F03G 3/08; B61B 13/00

(52) U.S. Cl. 185/33; 185/31; 104/289

(57) ABSTRACT

A set of Gravity Power Towers with built in intelligence and connected with each other with a transport guide ways or path ways for the mass to be transported on wheels, form the transport network for transporting people and cargo point to point, powered by gravity. A Gravity Power Tower is a gravity based embodiment for storing substantial potential energy in a number of relatively heavy and vertically moving masses, embodied as Power Mass Modules; release the said potential energy in a controlled manner using a continuously variable intelligent gear system and high speed traveling power transmission cable; the force so applied to accelerate at a fraction of acceleration due to gravity or sustain at steady speed any rolling mass of relatively of a fraction of the size of the masses in said Power Mass module; along a generally horizontal or graded path way; and when the said rolling mass needs to come to halt, the embodiment converts the kinetic energy back to augmenting the potential energy of the vertically moving masses in the Power Mass Module; any shortfall to gain back original status of the potential energy of the masses is made up using external energy like electrical motors; thus the embodiment creates new gravity powered elevated and underground railway, gravity powered road way and gravity powered runway at airports.

### TECHNICAL FIELD AND APPLICABILITY TO UTILITIES

The invention relates to energy conservation in transportation field by bringing into action hither to neglected gravity to power rail, road and air port to minimize wasteful use of precious energy and provide improved eco-friendly transportation for people and goods at lowering costs.

### BACKGROUND OF THE INVENTION

Energy is a serious concern of the world and transport does need energy in cities and inter city travel too. Even electrically powered metro rail though avoids local pollution in a city area, may still be drawing power from coal fired thermal power stations. Any measure which can reduce the energy needs, particularly produced using fossil fuel will go a long way to have sustainable development model of infrastructure.

Gravity force though available is perceived more as a force to fight and overcome, in transportation! But if we are able to draw this force as a pro-active partner, by re-engineering our infrastructure, we may find means of reducing significantly the dependence on other form electromagnetic energy, generated from burning fossil fuels.

In development of infrastructure for transport, as a principle, we should try to reduce the dynamic mass as much as possible commensurate with requirements of safety and comfort of users and bring in the gravity as a pro-active partner to provide thrusting force needed to move the mass and accelerate to reach such a speed and gain enough momentum, the said momentum so optimized to be able to carry the mass to its next point of service if possible or top up the smaller quantity of energy to maintain the state of motion, and then while stopping recover as much of the kinetic energy as possible is the goal. Actually it is during acceleration that high peaks of energy demand s arise and we lose high quantum of energy in deceleration of the units.

### PRIOR ART

The transport of people and cargo in cities and in between cities is a major concern to all the governments. The road infrastructure uses rubber tired systems, having three serious limitations namely; the lineal loading is limited and so soon with increasing traffic the roads get congested with falling average speeds and reduced fuel economy for any expansion right of way involving large areas of precious land will be needed, creating serious conflicts of interest between owners and the government leading to prolonged project realization times adding to serious cost escalations; the higher friction of road vehicles on the road does not lead to efficient use of fuel and adversely affects fuel economy as compared to steel rail on steel wheel.

Air transport is highly fuel intensive transport system and does not help any way within cities as well as short haul as well bulk long haul situations.

The steel wheel on steel rail, using single flange coned wheel pair, gives both high speeds and higher loading density per unit area of land use leading to most efficient land use. However they lack the flexibility to be adopted in cities without disturbing the habitat unless taken underground, which then becomes very expensive and takes long time to deliver the project. But currently railway is is in use using electrical traction to reduce pollution, using three phase asynchronous motors with electronics to recover some energy from the braking, which is fed back to the network. The execution of such projects too have become quite difficult in cities because they need to severely modify the habitats for large land areas needed for stations and yards as well to accommodate the railway geometry which does not fit road geometrical layouts even if one wants to construct as an elevated railway system along the roads.

An improved railway has been proposed under the name of “Skywheels-New Mass transit system” by Bojji Rajaram and published in proceedings (pages 420-424) at l' Convegno Internazionale “LE FERROVIE, NEI TRASPORTI DELGI ANNI 2000 BOLOGNA, 12,13,14 Apr. 1989 and also further described as Suspended coach transportation system; (reference U.S. Pat. No. 6,688,235 Inventor Rajaram, Bojji) which makes the railway flexible to adopt by suspending the coaches or containers underneath the bogie frames, the said bogie frames having wheels riding on railway tracks held in a concrete box enclosure, the said concrete box supported at suitable intervals on columns located at the median of a road. But the drive in this case also is the same three phase asynchronous electrical motors but the dead weight of the rolling stock has been considerably brought down as compared to conventional metro rails.

A novel gravity powered surface transport covering road, rail and airport system is presented to make it possible to move people and cargo within city as well as from one city to another, whereby substantial energy conservation is made possible by drawing heavily on the gravity force.

### DESCRIPTION

A set of Gravity Power Towers with built in intelligence and connected with each other with a mode of transport guide ways or path ways for the mass to be transported on wheels, form the transport network for transporting people and cargo point to point, powered by gravity. A Gravity Power Tower is a gravity based embodiment for storing substantial potential energy in a number of relatively heavy and vertically moving masses, embodied as Power Mass Modules; release the said potential energy in a controlled manner using a continuously variable intelligent gear system and high speed traveling power transmission cable; the force so applied to accelerate at a fraction of acceleration due to gravity or sustain at steady speed any rolling mass of relatively of a fraction of the size of the masses in said Power Mass module; along a generally horizontal or graded path way; and when the said rolling mass needs to come to halt, the embodiment converts the kinetic energy back to augmenting the potential energy of the vertically moving masses in the Power Mass Module; any shortfall to gain back original status of the potential energy of the masses is made up using external energy like electrical motors; thus the embodiment creates new gravity powered elevated and underground railway, gravity powered road way and gravity powered runway at airports.

Further the embodiment has fly wheel energy storage to capture and retrieve any kinetic energy that the vertically moving masses acquire after driving the rolling masses and need to be halted; the embodiment has built in intelligence to manage all the energy delivery, recovery operations, and to communicate with other intelligent controllers on rolling masses and other Gravity Power Towers in the network;

The embodiment thus eliminates need for any energy generating source on the rolling mass itself reducing the dead loads to be carried; conserves energy to a large extent if it is a case of linearly oscillating system like urban mass transport where start, speed, stop cycles repeat; the electrical energy used at the Gravity Power Tower is only to make up for the hysteresis losses in friction which is a fraction of the total energy drawn; the alternate sources of generating electrical energy using wind or solar power, will be sufficient to provide the low power requirements of gravity towers to recoup, and the the embodiment allows generation of of many orders larger power generation from stored gravity energy for use in continuous acceleration of rolling masses to high speeds in a short time which is not possible by use of existing electrical motors typically in rail based systems; the embodiment thus for the first time brings into action the largely untapped source of gravity energy to provide gravity powered transport to meet human needs and reduce carbon emissions on our planet to improve quality of life at progressively reducing costs because gravity is naturally free for us and available all over the planet.

The invention allows more efficient use of our limited energy resources leveraging gravity power to make our habitats pollution free and ease the congestion in urban areas.

### DESCRIPTION WITH THE HELP OF FIGURES

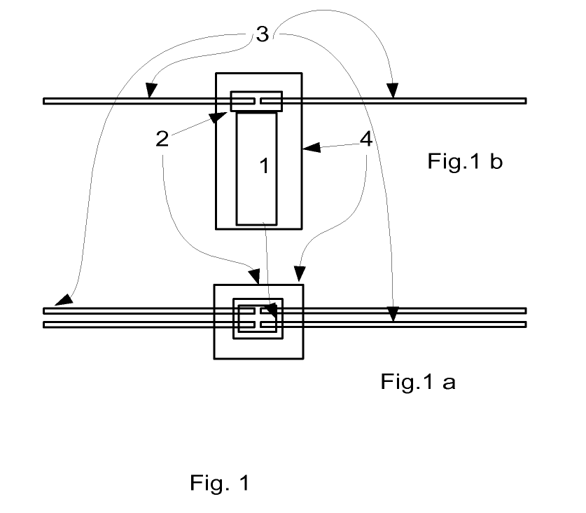

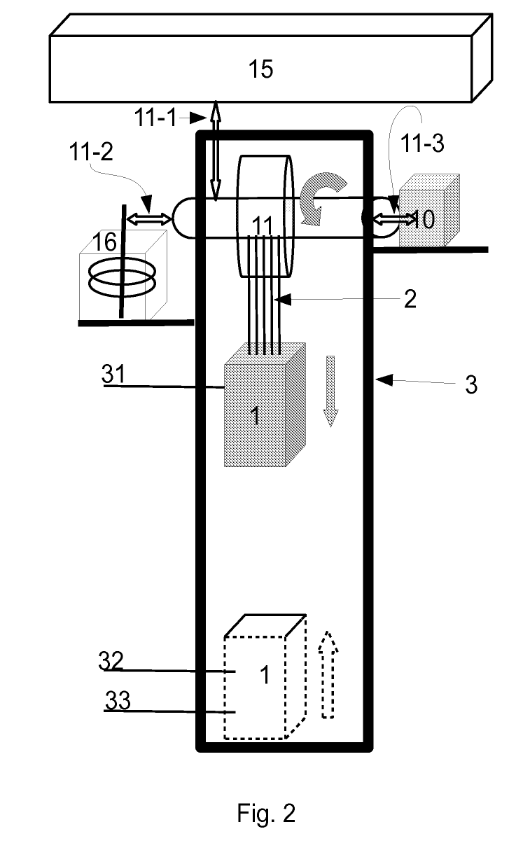

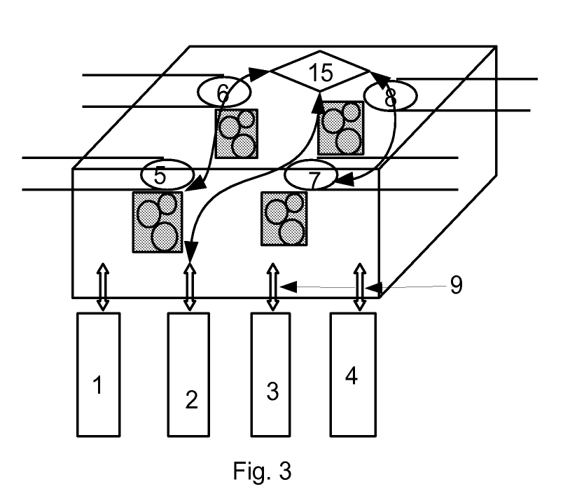

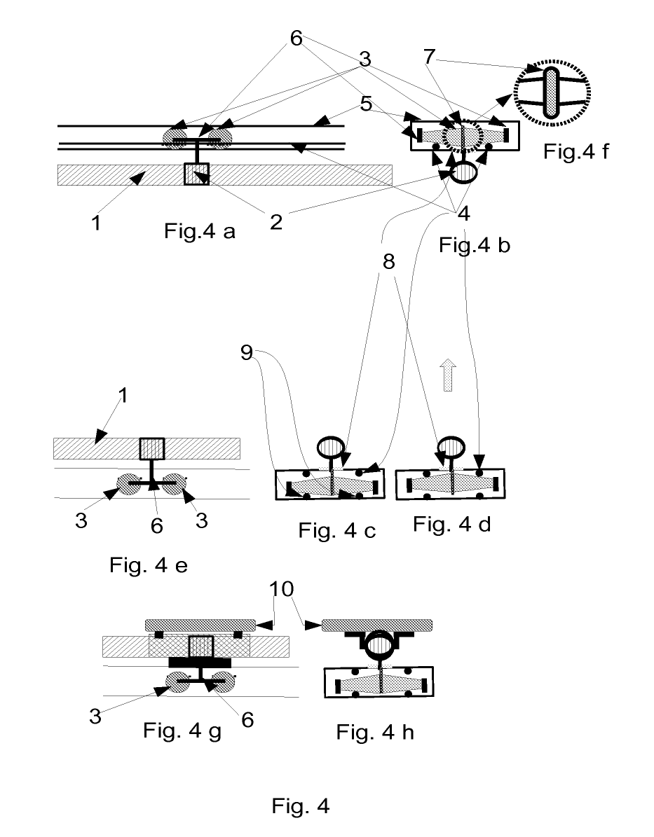

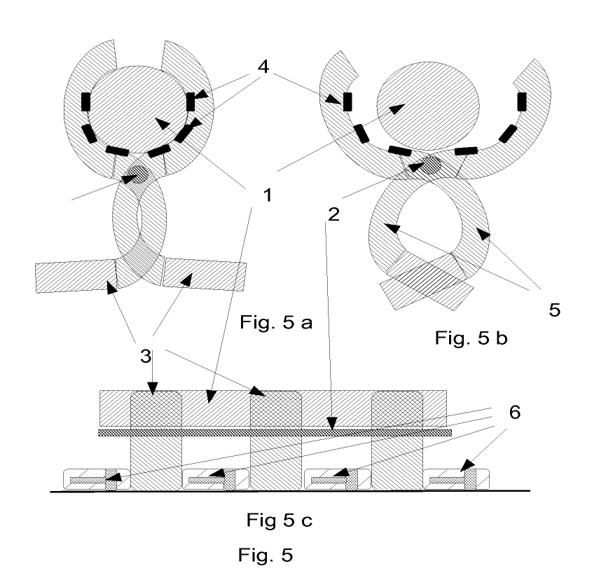

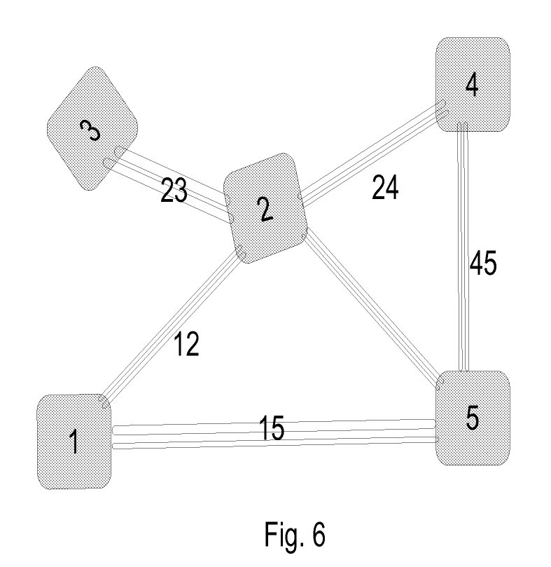

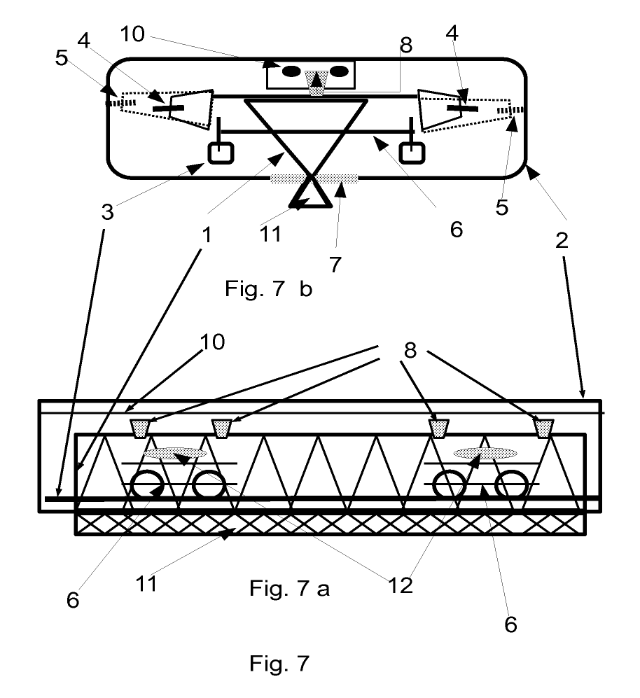

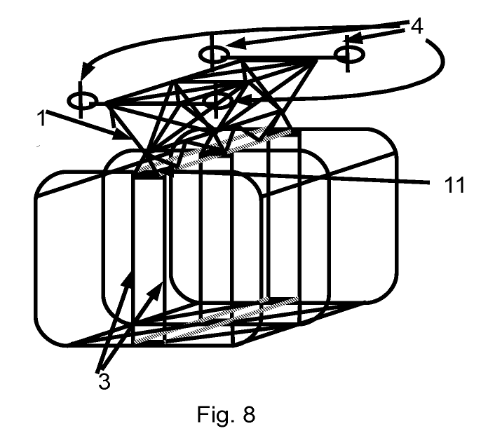

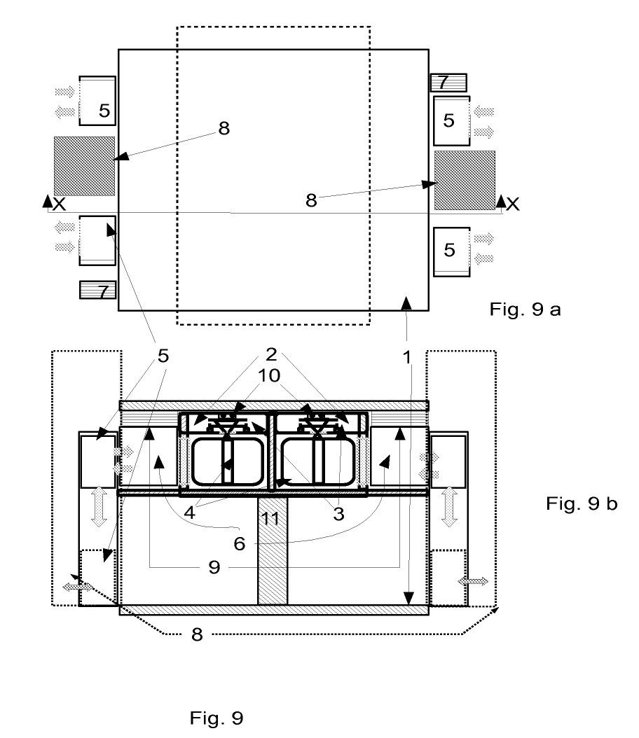

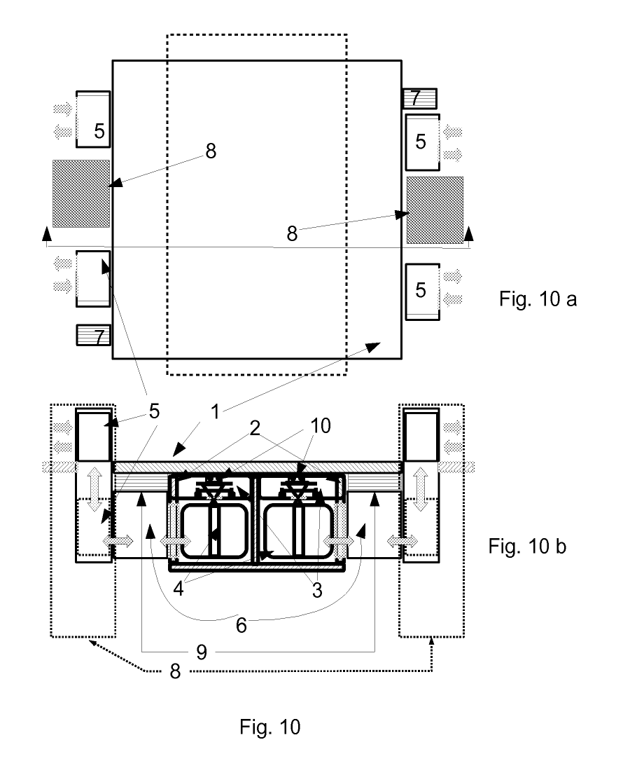

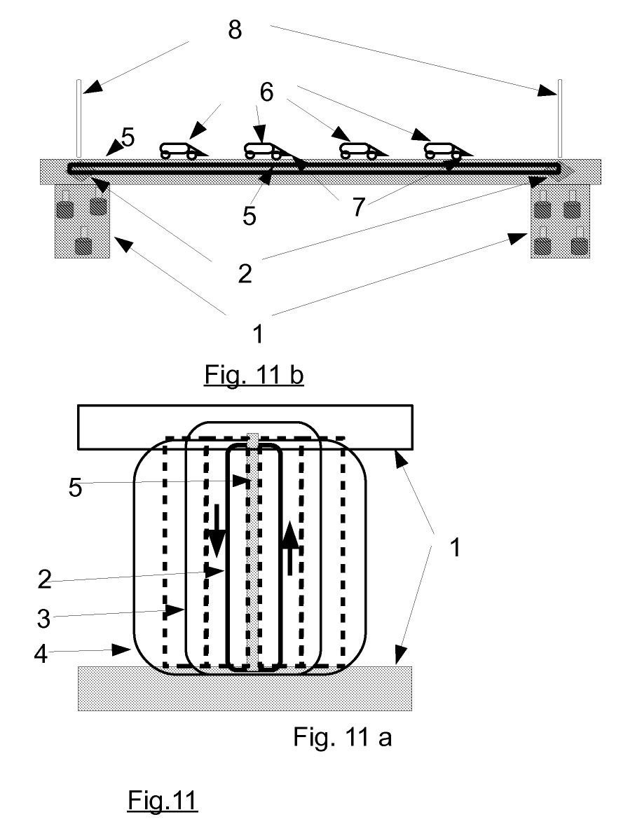

Description with the help of drawings:

| | |
|---|---|
| FIG. 1 | General arrangement of views plan FIG. 1 a and elevation FIG. 1 b of Gravity |
| | Power Tower modules |
| FIG. 2 | Cross sectional schematic view of Power Mass Module and its sub-systems |
| FIG. 3 | A view of the Main Gear Systems connecting Power Mass Modules and High |
| | Speed Power Transmission Cables. |
| FIG. 4 | Details of High Speed Power Transmission Cables |
| FIG. 4 a | Longitudinal sectional view of a suspended & guided Power Transmission |
| | cable, for a rolling mass traveling below |
| FIG. 4 b | Cross sectional view of Power Transmission Cable suspended beneath double |
| | coned single central flange twin roller mounted frame supporting the said |
| | cable |
| FIG. 4 c | Cross sectional view of Power Transmission cable for a rolling mass |
| | traveling above - rolling mass above and power cable below case |
| FIG. 4 d | Cross-sectional view of Power Transmission Cable with rolling mass riding |
| | above, with grips of the rolling mass engaged with the cable |
| FIG. 4 e | Longitudinal section of Power Transmission Cable guided and supported |
| | from beneath with rolling mass riding above. |
| FIG. 4 f | Longitudinal view of power transmission cable with steel plate interface for |
| | electromagnetic coupling with the rolling mass grip arm having matching |
| | electromagnet. |
| FIG. 4 g | Cross-sectional view of Power transmission cable equipped with steel plate |
| FIG. 5 | Schematic views of grip arm |
| FIG. 5 a | Cross sectional view of grip arm clamping on to the power transmission |
| | cable |
| FIG. 5 b | Cross-sectional view of grip arm in open condition. |
| FIG. 5 c | Longitudinal cross sectional view of the grip arms and connection to the |
| | rolling mass |
| FIG. 6 | Schematic view of multiple Gravity Power Towers forming a network |
| | connected by transport pathways/guide ways to transport rolling masses point |
| | to point in a city or even from city to city. |
| FIG. 7 | Schematic View of the basic module for Gravity Powered suspended coach/ |
| | cargo rail transport. |
| FIG. 8 | View of shell fully integrated structurally with the space frame spanning the |
| | running bogies over-head, providing rigid fully torsion-resistant connectivity |
| | for coach to carry passengers |
| FIG. 9 | General arrangements of the station at an elevated suspended mass rail |
| | system drawing power from a Gravity Power Tower grid |
| FIG. 9 a | Plan View showing location of access points, the Gravity Power Tower |
| FIG. 9 b | Cross Sectional X-X view of the twin modules for the gravity powered rail |
| | system for suspended mass transport. |
| FIG. 10 | General schematic view of an underground rail system powered by gravity |
| FIG. 10 a | Plan view at ground level for the access lifts and the location of Gravity |
| | Power Tower with its well underground housing the Power mass Modules. |
| FIG. 10 b | Cross sectional view showing the access lifts, the twin modules housing the |
| | gravity powered rail system for transporting suspended masses. |
| FIG. 11 | Gravity Powered Road way. |

With reference to FIG. 1, the Gravity Power Tower is a concrete or steel frame structure housing a number of Power mass modules shown as 1, with the main gear system 2 linking the pulleys driving the power transmission cables 3, the said power transmission cables extending along the pathways over which rolling masses have to be transported using gravity power. Each of the modules will now be described.

### Power Mass Module

Description of the Power Mass Module with reference to drawing Ref FIG. 2: A steel frame 3 supports a shaft at both ends having a drum and gear systems 11, gear connectors 11-1 linking to main gear system 15, gear connector 11-2 linking to a fly wheel energy storage system 16, and gear connector 11-3 linking to an electric motor 10, all of which are bi-directional as needed; the shaft gear system 11 has a drum, and with multiple wire ropes one end fixed inside the drum, and wound round the drum, with the other ends fixed to a mass 1; when fully wound up, the mass is at position 31; the said gear connector 11-1 when engaged connects the rotating shaft gear 11 to a main gear system 15, the gear unit 11-2 when engaged connects the shaft 11 to a flywheel system 16, and when the gear unit 11-3 is engaged, the said shaft gets connected to a geared driving electric motor 10. The multiple wire ropes forming the cable holding the mass 1 at position 31, allows the mass to reach position 32, in fully unwound condition, but while getting unwound the drum turns the shaft 11 in the same direction as the drum. Similarly when the drum is wound back, the mass rises to position 31 when fully wound.

Working of the Power Mass Module: Case of demand for power rising from zero to a maximum value: When the said mass 1 is at 31, the condition is said as the maximum charged condition, that is full potential energy of the module is available. When the shaft-gear 11, engages gear connector 11-1 to main gear system 15, and disconnects 11-2 as well as 11-3, and allows the mass 1 to fall under gravity, the gear system receives this energy input, while the mass 1 loses its potential energy. Till the mass 1 reaches position 32, the mass 1 exerts a steady force and delivers the power to the gear system but as it reaches position 32, the mass 1 will be having a velocity downwards, and this kinetic energy needs to be recovered to prevent impact forces and damage by the mass 1. The shaft gear system 11, will now disconnect the gear connector 11-1 from the main gear system 15, and simultaneously engage the gear connector 11-2, so that the fly wheel system captures the energy and brings the mass to a halt by the time mass 1 reaches position 33.

The embodiment is such that at any given time before reaching position 32, if there is no need to draw power from the Power mass module as indicated by the main gear system 15, the shaft gear system 11 can activate the gear connector 11-2 and while disconnecting the 11-1 from gear system 15, and recover whatever kinetic energy that the mass 1 may have at that time to bring the mass to a safe halt.

Case of demand for power at a particular starting value: As mass 1 is falling under force of gravity, the acceleration being constant, the velocity linearly rises with time and so the state of kinetic power of the mass also linearly increases. The velocity at which the force has to be delivered by the mass 1 is demanded by the gear system 15, then, the shaft gear system 11 will allow the mass 1 to drop, to reach the level of the velocity needed connecting the gear connector 11-2 and transferring any extra kinetic energy to the flywheel system 16, and once the needed velocity is reached, the gear connector 11-1 will be engaged to gear system 15, to deliver the force at the required velocity. Throughout the above two operations, the gear connector 11-3 remains disengaged.

Case of recovery of energy from gear system 15: When gear system 15 demands that kinetic energy has to be absorbed by the power mass module, the shaft gear system 11, activates the gear connectors, which can have any desired gear ratio, 11-2 and 11-3 to roll up the drum on the shaft to wind the cables, thus moving the mass up wards. While the mass 1 is thus moving upwards, the shaft gear system, at the time demanded by the gear system 15, engages 11-1, dis-engages the gear connectors 11-2 and 11-3, and allows the mass 1 to be lifted up by the force being received from the gear system 15. After this operation is over, shaft gear system 11 will disconnect 11-1 from gear system 15.

Any balance lift needed for the mass 1 to reach back its original position of 31, the gear connectors 11-2 and 11-3 are engaged, and using the energy of flywheel system and the motor 10, the mass 1 is restored back to its full potential energy.

Each such Power Mass Module has an in built intelligence, comprising of embedded microprocessors and transducers to monitor status, receive commands from a similar embedded intelligence of the main gear system 15, coordinate the actions to be taken to operate the gear connectors at the required gear ratio as needed and start and stop the electric motor as needed, do all the acts and things as described above, and be able to give information at any given time regarding the power status of the Module including that contained in the flywheel storage.

### Main Gear System and Principles of Control

Description of the main gear system module with reference to FIG. 3: The main gear system module has the power transmission cables with their end pulleys and attached individual gear systems 5,6,7,8 all mounted on a steel frame structure, the said power transmission cables extend from the main gear box system outwards in a generally horizontal direction over the pathways used by a mass to be transported;

The gear connectors 9 of the multiple power mass modules, each of which may be set to have a desired gear ratio, also extend into this main gear box system in such a way that any of the individual gear systems and pulley of a power transmission cable can get connected to any one or more than one of the power mass modules to draw energy or give back energy.

All the gear boxes of the power transmission cable, the gear connectors of the power mass modules, are linked to the intelligent main gear system controller 15, which commands the setting of the gear ratio for each individual pulley with gear box of the power transmission cable and chooses the appropriate power mass module too for driving the pulley or to recover energy.

The intelligent main gear system controller 15, monitors the speed and force in the power transmission cable, draws energy from the power mass module if needed by any of the power transmission cables, or arranges to recover energy from any of the power transmission cable by connecting to one of the power mass modules ready to receive energy, or if the force and the speed of the power transmission cable is to be maintained just over coming the friction losses, arranges the same from one of the suitable power mass modules, in all the above said cases, choosing the appropriate gear ratios for the pulley-gear system of each individual power transmission cables.

### Principle

The principle the main gear system uses is, knowing the power status of each of the power modules, and the force requirement for the power transmission cable, as well as the final velocity to be reached for the rolling mass to be driven by the power transmission cable, or the velocity of the rolling mass whose energy is to be recovered, the main gear system will follow the equation

F·h=f·(v/2)·t where
F=Power mass x acceleration due to gravity
h=free height of travel available for the power mass at that moment, down ward if energy is to be given, and upwards if energy is to be gained,
f=F/n, n being the resultant gear ratio chosen by the main gear system controller for the power transmission cable pulley-gear system and the gear connectors of the Power Mass Modules used,
v=the maximum velocity to be reached by the rolling mass driven by the power transmission cable or the velocity of the rolling mass the energy of of which is to be recovered
t=the time taken to accelerate to ‘v’ or decelerate from ‘v’ to rest.

In case multiple Power Mass Modules are used, say F(i) with different h(i) where i=m, and m is the number of such Power Mass Modules, then Sum of F(i)·h(i)=f·(v/2)·t over i=1 to m where m is number of Power mass Modules used.

If it is a case of just keeping the rolling mass moving at a steady speed v, over coming the resistance, then the equation is F·(v/n) =f·v and since F, f and v are fixed, value of ‘n’ that is the gear ratio is adjusted suitably and in real time corrected. In dynamic conditions actually it is power balancing—not just the forces. So it is expected that v and v/n will differ by minute amounts and sensing the same,the ‘n’ value is fine tuned. It may be noted that F could be from one power module or sum of more than one power modules. So for different F values from different power modules, we will get a matching number of n values, but following the principle mentioned above such that Sum of (F(i)·v/n(i)) tends to equal f·v, where i=1 to j and j is the number of power mass modules.

The main gear system controller gets inputs from the power mass modules regarding their status, the current force and speed status of the power transmission cable; requirements of the rolling mass on the guide way, whether to be accelerated up to a specified speed or decelerated to be stopped, or maintained at a steady speed; chooses one or more number of suitable power mass modules, works out the optimum set of gear ratio values, sets the gear ratios for the Power mass Modules and the Power Transmission Cable, and at the right time puts together the Power mass Modules and the pulley-gear system of Power transmission cable to act on the rolling mass; In real time the main gear system monitors the force value and the speed of the power transmission cable, distance traveled and keeps on adjusting the set of gear ratio values to make sure that object is achieved.

### The High Speed Power Transmission Cable

The Power Transmission Cable system: The Power Transmission Cable is a high speed traveling closed loop cable 3 as in FIGS. 1 and 5, 6, 7, 8 in FIG. 3 with one end looping around a pulley-gear system, and located and acting as part of the main gear system 2 in FIG. 1 of the Gravity Power Tower, and the other end projecting out of the main gear system and out of the Gravity power tower, generally in a horizontal plane, including grades normally obtained, extending, along the guide way or pathway, up to a length needed to deliver power to a rolling mass on the pathway or guide way, in case it is necessary all the way to the end of the pathway where another Gravity Power tower occurs, and winds back on another end pulley only or pulley-gear system in case the location is another Gravity Power Tower. While one leg of the cable engages the rolling mass to be given power, the return path of the cable may be idle or it may be used in certain cases, to drive rolling masses in the opposite direction on another guide way.

The Power Transmission Cable may be required to drive or stop a rolling mass traveling underneath the cable or the rolling mass could be riding above the Power Transmission Cable.

Normal wire rope used as cable for this purpose, needs to be supported to avoid sag and the friction of travel at speeds typically of the order of 30 to 35 m per sec while transmitting the power needed for the rolling mass. So special supports traveling in metal enclosure acting as guide as well as house a specially made frame with double coned high speed rollers, which hold the cable and provide dynamic support to the cable are now described with reference to FIG. 4

With reference FIG. 4: A continuous rectangular metal box enclosure 5 as in FIGS. 4a and 4b with a slit opening 8 as in FIGS. 4c,d,e in the middle of one long member, running throughout through which the support arm 2 projects and holds the cable in FIG. 4a and FIG. 4b, the said support arm firmly fixed to a frame 6 with a pair of double coned rollers 3, as in FIGS. 4a and 4b; the double coned rollers run over two steel rounds 4 in FIGS. 4b, 4c, 4d fixed on the either side of the slit opening, when the cable is traveling below the support metal guide box, the said metal box's longer member without slit fixed to a ceiling member of the structure housing the guide way for the rolling mass, FIG. 4a and FIG. 4b;

The double coned rollers also have a common double sided flange 7 as in FIG. 4a and amplified as in FIG. 4f, at the middle, the said middle portion being of larger diameter than the ends of the roller, thus the roller executes sinusoidal motion while rolling on the steel rounds allowing for higher speeds and negotiate curved pathways with lowered wear, as in railway wheel sets;

Referring to FIGS. 4c and 4d, when the guide way is such that the power transmission cable has to be at the guide way level or below wheels of the rolling mass, then the guiding metal enclosure gets fixed with the long member having the longitudinal slit opening on top, with power cable traveling on top of the metal box, with the long member of the rectangular box with no slit becoming bottom member and fixed to the guide way of the rolling mass, with an additional pair of steel rounds 9 fixed on the long member of the metal box, the said rounds 9 are parallel to the steel rounds 4 on the long member with central opening, but distance between them adequate for allowing the double coned rollers at any time to be in touch with only one pair of them, all along over which the double coned rollers rest and run when cable is running above the metal box without any rolling mass attached on top. When the rolling mass is coupled to the Power Transmission Cable, at the location of coupling, the double coned rollers get lifted up and roll on the steel rounds 4 as in FIG. 4d.

The power transmission cable has another element called gripping arm reference FIG. 5, one end of which is attached firmly to the rolling mass, and the other end has a pair of grips 5 with in built rollers 4, as in FIG. 5b which at low pressures of initial gripping action, allows any relative velocity difference between cable 1 and grips 5, to be absorbed by rolling and avoiding friction and heat, but the same rollers when fully pressed with full force, get pushed in to the grips and the cable and grips get firmly engaged FIG. 5a; The grips are scissors shaped with a pin 2 around which the s shaped grips, when the ends 3 are pressed together, the ends 4 move in and grip the cable firmly; Further at the fixed end on the rolling mass, the grip has a number of shock absorption units 6, FIG. 5c, to absorb and minimize any shocks of attachment of the grip on to the moving cable.

The Power Transmission Cable has intelligence built in with capability to communicate with the main gear system and gravity power controller, to decide on timing and the force for operating the grip arm and also whether the said force comes from a fly-wheel energy storage or a compressed air motor located on the rolling mass and the timing for operating the grips to hold or release, decided through communications between the rolling mass and the power cable controller depending on the requirement of the rolling mass to draw energy or not.

In another embodiment, a steel plate fixed on top of the cable at each support frame as in FIG. 4g and 4h, that means the cable is between the metal box in which the supporting frame runs, and the steel plate, so that the rolling mass can have an electromagnet which when powered can activate magnetic force of attraction to make the rolling mass get pulled by the cable.

### Gravity Power Tower Controller

Gravity Power Controller is the microprocessor based embodiment comprising of built in intelligence and control functions with communication capability with all concerned sub-assemblies, the said sub-assemblies being the rolling mass controllers, power cable controllers, gear system controllers named as gravity power controller for each gravity power tower, which in turn communicate with other gravity power controllers with which it has operating relation ship, thus forming a networked gravity power control system is an integral part of the gravity power transportation;

the gear system with its controller, is an embodiment capable of continuously variable gear ratio, to which the power masses are connected through a cable and drum, to be lifted or dropped, as required, to which all the power transmission cables which are end less looping cables with two pulleys at the either end, the pulleys axle having extension with gears to be engaged as needed by the gear system and the said pulley and gear of every power transmission cable becomes part and parcel of the gear system; the gear system having in built microprocessor system to receive inputs from the tensions in the power transmission cables, the speeds, accelerations/decelerations of the rolling masses, the positions of the power masses and the remaining potential energy which can be tapped, and plans based on information received from the controllers on the rolling masses and their requirements, the action to be taken either to give energy or recover energy from a given power transmission cable, and accordingly chooses the power masses depending on their position to deliver or receive energy, and further monitors the status of power masses and if there is kinetic energy in a power mass, the same is immediately recovered connecting the same to a set of fly wheels, and if there is finally a need to make up for height to be lifted for any particular mass, to reach its maximum potential energy state, applies electrical motor power to cover the gap lifting the said mass; further at the time of transfer of kinetic energy back to masses, the shock and impact is controlled by using the energy from the stored in fly wheels, and make the initial upward movement for the mass or set of masses nominated to be connected to a power transmission cable delivering kinetic energy from a set of stopping rolling masses;

the controller of a power transmission cable monitors the force in the cable, and compares with safe allowable limits for the said force, its speed, direction, the type and requirements of the rolling masses it is handling, the nature of its function, whether it is delivering power to rolling mass or taking out the power from the rolling mass, and keeps the gravity power controller posted with the latest current status

### Applications in Rail, Road and Airport Modes of Transportation

Description of applications: A city or area to be served by transport based on gravity power, will have a typical layout as shown in FIG. 6. As in FIG. 6, a group of Gravity Power towers, 1,2,3,4, 5 are connected by the transport routes, but the power transmission cables 12,24,23,25 etc need not be the same length as the route lengths particularly in case of railway! In case of railway cruising length under no power and the chosen acceleration rate for the chosen speed to be reached, decides the lengths of these cables, the rolling masses thus launched travel under own momentum to reach the next Power transmission Cable, to get controlled slowed down and brought to a halt at the destination station where the next Gravity Power Tower also is located.

The transport mode could be rail based or road based or even water canal based, or be an airport where airplanes could be launched out and received, with the appropriately placed power transmission Cables.

The great advantage of gravity Power Tower is very high quantum of energy can be released in very short time and during idle time and non-peak period, relatively low power electric motors used to charge back the Power mass Modules to their full potential energy.

### Gravity Powered Rail Module for Elevated and Underground Suspended Mass Transport.

For a railway system based on Sky-wheels, the application of the gravity power as the prime moving energy is now described; The Sky-wheels system, Ref: . . . takes the normal railway track and the two bogies, each said bogie with a pair of standard wheel sets having single flange coned wheels, the said wheel sets riding over standard canted rails fixed at standard gauge, the said whole embodiment of track and bogies with their connecting standard under-frame, enclosed in a rectangular box typically made of pre-stressed concrete, with railway track at bottom long member of the rectangular box; the said railway track provided with a continuously running opening in the middle of track to allow suspenders fixed to the under-frame over the bogies, to pass through out of the box down wards, and the said suspenders holding a coach supporting the same in suspended mode; standard railway electrical traction using third rail for current collection and bogie mounted electric motors driving the axles; standard signal and train control as in railway form the characteristics of the system; such rectangular boxes placed next to one another in parallel and supported at middle by tall columns rising from the median of a road way form a route with two rail based suspended coach transport system;

In the citation U.S. Pat. No. . . . invented by the first inventor this application, the above said suspended coach transport system has been further distinguished by a pair of derailment preventing wheels mounted on the bogies, with horizontal axis of rotation, and rotating in a plane parallel to that of the wheel running on rail, but very close to the ceiling of the rectangular and provision of swing arrestors on the coach outside the rectangular box, to protect against excessive swing of the coach which is suspended by wire ropes or individual suspenders; However, the over all torsional resistance in horizontal plane against rotation about vertical axis for the suspenders is one weak point in dynamic stability which needs to be improved and also if we can provide for more lead time for acting against derailment happening by the process of a wheel rising and climbing the rail and going off the rail; it will improve the safety. The new innovation presented now improves on these short comings of existing art.

Gravity Powered Rail Module: Refer FIG. 7: FIG. 7a gives sectional elevation and FIG. 7b the cross section of the Gravity Powered Rail Module for use in rail guided transport. A rectangular box section typically of the size of 3 to 4 m in width, and 2.5 to 3 m in height made out of pre-stressed concrete material or steel or steel like material, with a central longitudinally continuous opening 7, at the bottom long member of the rectangular box forms the enclosure to hold all the components like railway tracks 3, the running bogies 6, power transmission cable 10 with its guidance and support box enclosure fixed to the ceiling of the box enclosure, the space frame 1 with part of it 11 projecting out of the opening at the bottom of the rectangular box enclosure; the grip arms 8 as described in para 4 and detailed in FIG. 5 mounted on the space frame riding on the bogies, the said grip arms facilitate connection to the high speed power transmission cable over head 10; and this said box enclosure with all its components as described afore forms the heart of the gravity Powered rail way and is named as Gravity Powered Rail Module for convenience of reference, here in after wards. The rail track is embodied such that the central opening 7 of the said box enclosure remains at he middle of the track. The running bogies 6 ride over the rail track 3. The space frame 1 connects the two bogies 6, and carries the entire load of the mass either it is coach with passengers or a cargo in a container, rigidly connected to the projection 11 outside of and below the said box enclosure 2.

### Swing-Free, Derailment-Free and Anti-Capsize Rail Transportation

The mass carried and the space frame riding on the bogies are thus structurally integrated not to allow any swing of the mass suspended below. The projection of the part of space frame out of box 11, is a space frame by itself and as it continuously gets integrated with the mass to be carried all along, the torsional resistance against any rotation of the mass carried with respect to the frame over the bogies is improved many orders more than what one gets with only a few suspenders are used to hold the mass in suspended mode.

Further there are four of solid rubber tire wheels 4 mounted on a retractable support to rotate around an axis perpendicular to the axis of rotation of the steel wheels riding on the track; these rubber tire wheels stay very close to but do not normally touch the inner sides of the box enclosure 2, as in position 4, except when needed to be run against the walls as 5 in FIG. 7b, to collect energy for fly wheel storage 12 on the bogies, or to cause emergency braking if needed by use of disc brakes mounted as part of the rubber tire wheels which gets initiated when a lateral acceleration of more than 0.35 g is detected by the on board computer. When these rubber tires laterally engage the side walls as afore mentioned, the bogie with wheel sets has no way to derail thus preventing any possibility of derailment.

This is much better than the current embodiment in the cited U.S. Pat. No. . . . , where actually derailment has to initiate for the rubber tire there to engage the ceiling. The current embodiment differs from the cited patent, in that the axis of rotation for the rubber tire wheels is vertical in this application as against the horizontal axis of rotation used in the said cited patent.

Further the embodiment presented in this application for the rubber tired wheels provides for multiple functionalities of feeding energy to fly wheel energy storage, emergency braking as well as derailment prevention by anticipation of the same and hence a substantial and material improvement over existing art.

A typical integrated coach shell 3 which is structurally and seamlessly integrated with the space frame 1 through 11 is shown in FIG. 8; the frame 1 in FIG. 8 over the bogie carry within their space, compressed air reservoir, to supply power to braking, fly wheel energy storage 12 as in FIG. 7b, energy obtained from four solid rubber tire wheels, mounted 4 in FIG. 7a and FIG. 8 on the bogie frame, their axes of rotation perpendicular to that of wheels of the running bogies, the said rubber tire wheels can run against the side walls, 5 in FIG. 7b only when so engaged to feed energy to flywheels at as the coaches get launched, the said solid rubber tires when idle travel with a short gap as in 4 in FIG. 7b separating from the side walls of the box enclosure,and serve also as derailment preventing system for the bogies; further the said solid rubber tire wheels also serve for emergency braking, when they get pushed to bear against the side walls and disc brakes applied to stop the motion using the friction between the rubber and the concrete surfaces.

All the power needed for lighting, operating the low power electronics and microprocessors on board of the coach, opening and closing of doors at stations, is met by a battery pack getting recharged by the fly wheel energy storage or by the compressed air reservoir supply; at every gravity power station, the air inside the coaches get replaced by fresh conditioned air by close to 50% and only a small reservoir of conditioned air pressure tank is carried by the coach in its bogie frame, to be used for any unforeseen emergency; thus there is no on board equipment for the air condition load management; this is possible because gravity Power stations occur every one or two minutes in the running of the coach;

Since there is no electrical motors traction control equipment to be carried by the bogies, including air condition equipment, the dead weights are substantially reduced for the rolling mass, increasing revenue earning pay loads;

The said Gravity Powered Rail Module as described in para 7, the entire embodiment is replicated and the two or more such enclosures structurally integrated horizontally and supported with vertical columns rising from ground for elevated systems or a large concrete box structure enclosing the coaches too, buried under ground to provide multiple routes; these will be now described in detail.

In case it is an elevated metro rail, the twin Gravity Powered Rail Modules are integrated into a middle hollow beam, the said beam supported on columns of such height to clear the bottom of the suspended coach from the tallest vehicle moving on the roads, and at intervals to span longitudinally parallel to the two tracks, the said columns being located at the median of the road way or by one side of the road route as convenient, or even supported by a cable stayed bridge arrangement, if long uninterrupted spans are needed.

In case of under ground metro rail, the two boxes are integrated with a common wall, which extends down below in to ground, the box top remaining at the road level, and the extreme side walls also extends by the depth required to reach bottom of the suspended coach, thus forming a twin boxes in which coaches travel, and the top twin boxes in which the bogies and the frame travel; the access will be from the foot paths, and just the opening required to cover the door widths will be provided with its own platform doors; the entire depth of excavation being of the order of 7 to 8 m from road surface;

Since the system does not depend on rail wheel adhesion, any grade being followed by road can be followed and, in the extreme case if required 10 m radius turn table will assure handling any sharp change of travel direction.

Typically such twin box enclosures carrying twin tracks, forming to and fro double line, can be construed as a suspended rail coach transport route based on railway and Skywheels concept either above ground as elevated system or underground; the train as we understand could be one single coach or a set of coaches;

The Gravity Power Towers get connected by such typical Skywheels based railway as described in paras 7 to 7.10, and the Power Transmission cables of the Gravity Power Tower now extend along the guide way followed by the rolling masses, in this case the four tracks, two tracks on either side of the tower. Since the bogies are accessible from the ceiling of the rectangular box housing the track and running bogies, the power transmission cables get suspended from the ceiling with their metal enclosures carrying the supporting frames with double coned rollers, the said metal box fixed to the bottom of the ceiling, all along the center lines of the track.

The Power transmission cables of two types are extended over the tracks from each of the Gravity Power Towers at either end of the route; one of shorter length equal in length to (0.5×(v/a)×v) where v is the maximum velocity that the coach or set of such coaches, has to be accelerated at acceleration ‘a’; and a second optional one which extends end to end from one gravity tower to another where needed because of topography needing supplementing of energy like severe grades or curves; normally launching velocity v is such that with hardly less than 10% loss of momentum even in typical grades obtained for railway, the rolling mass will reach the next Power Transmission cable to deliver its kinetic energy back to Power module at the receiving Gravity Power Tower.

### Gravity Powered Rail in Elevated and Underground Configuration

Elevated Gravity Powered Rail suspended coach system is shown in a general arrangement drawing in the FIG. 9 and similarly underground embodiment for the same Gravity Powered Rail suspended system is shown in FIG. 10. Except for the level of location with reference to the road way, the method of working and the various elements are the same in both the cases.

In the plan view in FIGS. 9a and 9b, a pair of Gravity Power Towers 8 are located on the side path/or by the side of the roadway, and 5 is the lift access to the access zone 6, ref FIGS. 9b & 10b which gives cross section view x-x. From this access zone commuters can board coaches 4, the said coaches could be moving in opposite directions on the twin routes. The coaches 4 are being supported and driven by the Gravity Powered Rail Modules 2, as described in para 7 and FIG. 7. Typically for underground case, just below the existing road surface, about 6 to 8 meters digging will be involved using cut and cover method, the entire structure except for the gravity power tower 8 portion where about 15 m deep well will be needed. For elevated Gravity Powered Rail suspended coach system, the supporting column 11 as in FIG. 9b could be about 10 m above the road surface. The Gravity Power Tower well accommodates the power mass modules. The Main Gear system control is located at 9 linking the gravity power modules and the power transmission cables 10 which deliver power to move the running bogies 3 on rail track with coaches 4, to reach the designed launching velocity and in case of an approaching running bogies with speed, recovers the kinetic energy, charging the Power Mass Modules in 8 with potential energy.

All available grades on existing roads can be handled by the Gravity Powered Rail module, because the traction is not dependent on rail adhesion but depends on Power Transmission Cables. In urban areas with undulating topography this proves to be a major advantage. Since underground option of Gravity Powered Rail does not require to dig deep for underground tunnels, it will prove to be very economical, being able to follow existing roadways both in alignment and grade.

Safety is enhanced as there is protection against derailment as well as capsizing of coaches, because the coaches cannot get separated from the tracks held inside the enclosure box, both for elevated and under ground options of gravity Powered Rail suspended systems.

Case of power supply failing and the train getting stranded in mid section away from station does not arise, because, unless adequate energy is available at the Gravity Power Tower to launch a suspended coach to reach the next station, the launching will not take place.

There are no emissions of fuel burning nor chances of electrical sparks or short circuits along the route of travel of the coaches, reducing vastly chances of fires and eliminating pollution too.

The regular train signal control systems are eliminated in the Gravity Powered Rail system, as positive control by the launching and receiving Power Transmission cables make sure of safety of the moving coaches and automatically controlled by the computerized control of the Gravity Power Control in coordination with the on board computer of the rolling mass.

rolling bogie controller in rail guided system, monitors the speed, direction, and current location, and advises its requirement for either to receive power or deliver back its power, the status of its fly wheel energy, its battery pack charge, the status of its compressed air energy and initiate action to correct any deficiency using the fly wheel energy, relative position with respect to another rolling mass, and control if needed to avoid collision, continuously monitor and maintain the prescribed speed profile within permissible range monitoring for the position of the power transmission cable, initiate action to move the grip arms to clamp on or detach from the said poer transmission cable, at the right time in coordination with the controller of the power transmission cable, exchange information with the gravity power controller and get instructions, and implement.

### Gravity Powered Road Transport

Application in road ways: In case of road vehicles, the arms of the power transmission cable are laid in the middle of the road lane all along, in a shallow close to surface trench, covered by a non-magnetic synthetic but strong cover, reference to FIG. 11 a, the underground gravity power stations are indicated in plan view FIG. 11a as well as in sectional elevation FIG. 11b, as 1, the road divider as 5, high speed lane of 65 mph as covered by the 2, one leg of the high speed power transmission cable goes in the direction of traffic, and the return cable follows the road lane with returning traffic, forming the end-less loop, similarly 3 is the medium speed loop driving cars at 45 mph and 4 is the power transmission cable driving cars at low 30 mph—but the speed ranges are indicative, power cables can be adjusted to give the desired speeds by design.

The power transmission cable at the location where the supporting frame with double cone wheels, also has a steel plate mounted at intervals of 10 to 15 m, with freedom to take a 30 deg dip from horizontal in the trailing direction of traffic;

The cars or road vehicles 6, in FIG. 11b will have no engines but have a fly wheel energy storage and a battery pack, but provided with an electro-magnet 7, in FIG. 11b, fitted at the front steering location at the apex of a triangle frame, the apex pointing forward and the base fitted to the axle connecting the two front wheels,

the said electromagnet so mounted that it also can take an angle of about 30 deg from the horizontal but facing the direction of motion, so that when the electro-magnet is switched on, the steering is automatically controlled by the pull exerted by the steel plate of the cable traveling below the road surface; the said triangular frame such that under the pull it gets extended by virtue of spring and damping components, and elongates in the direction of motion, to give the largest component of tractive force and minimize vertical on loading of the car; there will be no engine, and the flywheel is charged while being pulled by the power transmission cable, which in turn charges the battery pack to provide for powering the electromagnet, an electronic collision avoidance system, air conditioning and creature comforts inside the car;

Further when the traffic is controlled by signals, the gear system allows the kinetic energy of the rolling masses, to be transferred to the Power Mass Modules, when finally the a car wants to branch off to its parking location, the driver has to disengage his magnet, use the fly wheel energy to reach the parking lot. Again when re-starting he will depend on battery pack, to join back the gravity powered road. Unlike in rail based system, the Gravity powered road will have power transmission cables running just below the surface all along and and in each lane, with Gravity Power Towers buried below the road at such intervals as to energize a 6 lane traffic. Typically every mile or two we will need either underground gravity tower stations—thus effectively eliminating fossil fuels in automobiles for personal use, while retaining the pleasure of personal transport

In the embodiment for the controller module of the gravity power controller working in the car on the gravity powered road; the controller communicates continuously with the gravity power controller and the power transmission cable controller, with its position, speed and direction, and also with the similar controllers on cars running on left, right, behind and in front so that relative to each other safe speed profile is maintained, and will not allow the magnetic force disconnection from a power cable unless it is safe for the driver, and in case of emergency with cooperation of other controllers on cars can even disconnect from power cable itself apply brakes and stop not only self, but also the other cars, while cable controller in such a case will also take similar action to prevent any major mishap, the controller monitors and guides the driver of the car on the right conditions to change from one gravity power lane to another once it receives a request for the same from the driver, and also will not allow the driver to act when such proper conditions are not available; monitors for status of fly wheel energy storage, battery power storage and if needed replenish by drawing from own kinetic energy which is being fed by the power from the power transmission cable; monitors the switching on and off of the electromagnet as well extending of the arm in the front holding the electro magnet, to assure that timing and action are safe as done by the driver.

### Gravity Powered Airports

In case of airports, the power transmission cable is run just below the runway surface in the middle, in a slot covered by flaps of non-magnetic material, from which a steel plate assembly producing a flat surface perpendicular to the direction of motion of the cable, the plate in turn mounted on a base firmly fixed to the power transmission cable, so that when the cable travels, the plate moves, and the aircraft to be launched is provided with a matching electromagnetic pad, which when electrified becomes a magnet and attaches itself to the steel pad of the cable, with sufficient force, to allow the aircraft to be pulled as the power transmission cable delivers the necessary power; as the end of runway is reached and the aircraft gains the needed speed for take off, the electromagnet switched off and the air craft jets take over; at the time of landing the aircraft will find a pad traveling ahead almost at the same speed and will allow it own resistance pad to drop and engage, and once engaged the cable will start slowing down as the power masses get engaged to be lifted by the stopping aircraft.

The embodiment of the controller on the air craft desirous of drawing gravity power for taxiing, launching and landing keeps in continuous communication with the gravity power controller of the air port, as well as with the controller of the power transmission cable to which the aircraft is currently using, monitors the electromagnet pad to be engaged with the ready to launch and waiting power transmission cable on the runway, coordinates for the timing of launch with the gravity power controller and finally allows the pilot to initiate launching, and then continuously monitors from the moment of launch the speed build up and at the end of the transfer of the planned energy from the power masses, cuts off the electromagnet, when pilot takes over with aircraft engines; similarly when an aircraft is approaching for landing, the controller of aircraft is in continuous communication with the controller of the power transmission cable and the gravity power controller, and confirms that the power transmission cable is being run at the speed required, so that relative speed difference between the landing gear and the cable is minimized, and then gets the electromagnet lowered to position to couple with one of the steel plate pads of the cable, which gets confirmed by the controller of the power transmission cable, as well as by the controller on the aircraft, and this information is conveyed to the gravity power controller, and at that moment action gets initiated to couple up the power masses to be lifted and aircraft brought to halt.

Thus the present invention with its embodiment of vertically moving power masses, intelligent gear systems, with innovative high speed power transmission cables, allows the immense power of gravity to be used in energy intensive application for transport in all surface modes, rail, road and airports when very levels of energy is drawn at the time of accelerating heavy masses, and also the invention makes it possible to recover most of the energy spent when such heavy rolling masses are to be brought to a halt. The invention makes it possible for peak energy loads to be taken away from the normal energy sources like electrical power, and such peak loads only are making it difficult to harness alternate sources of energy like solar or wind energy in addition to their being climate dependent.

The natural phenomenon of human activity presenting peak poads in a 24 hour cycle, as much driven by the day/night routine dictated by the earths's rotation, provides for meeting peak energy requirements being met with stored potential energy which can be released at very high rates during such peak periods, and also recover a quite substantial amount to gain back the potential energy, the balance being made up during off peak period by using low levels of generated energy in a leisurely manner.

Just for appreciation even on very approximate estimates, taking into account that it is the period of acceleration of a mass that maximum power is spent and while coming to halt, which is inevitable for any mass in motion, again while braking most of the energy is lost as heat and unused; further rampant but unavoidable inefficient patterns of driving too causes avoidable energy loss; keeping in view that the present invention making pro-active use of abundant and free gravity to overcome these losses, with the implementation of this invention, the total fuel spent on transportation in a country could be saved almost 50% without compromising on our standard of life styles. The invention also makes it a simple technology to implement as all mechanical elements are well developed and no major research work will be needed to commercially implement the embodiments as described, in a very short time, which is an added advantage keeping in view the current energy crunch faced by our planet.

For the first time we have a viable solution to the serious critical problem the planet is facing with the rapidly reducing fuel supplies and rapid global warming.

The untapped power of gravity, not depending on any climatic factors nor any man made production facilities, through synergy with wind and solar power sources can be the future of assuring energy security through substantial conservation of energy generated from non-renewable sources of energy on our planet, in addition to tremendous improvement in environmental quality by cutting down the green house gas emissions, thus contributing to a major step to control global warming.

Although the invention has been described in terms of particular embodiments and applications, one of ordinary skill in the art, in light of this teaching, can generate additional embodiments and modifications without departing from the spirit of or exceeding the scope of the invention. Accordingly, it is to be understood that the drawings and descriptions herein are proffered by way of example to facilitate comprehension of the invention and should not be construed to limit the scope thereof.

What is claimed is:

1. An apparatus comprising of a set of networked Gravity Power Towers, each having a set of vertically moving extremely heavy masses called Power Masses and an intelligent variable main gear system; the said Gravity Power Towers interconnected with one or more similar Gravity Power Towers by High Speed Power Transmission Cables, end-less, roller supported and sag-free, the said Cables having own gear systems at either Gravity Tower and the said gear system gets engaged or disengaged with the said intelligent variable main gear apparatus of the Gravity Power Tower as per direction of the intelligent microprocessor actions; and the said High Speed Power Transmission Cables capable of gripping a rolling mass with built in microprocessors based intelligence and communicating with Gravity Power Towers; the rolling masses running over and along transport mode pathways like existing but suitably modified rail having a hour glass shaped space frame supported on two standard rails by bogies with pair of wheels running over two rails fixed on either side of an opening at the bottom member of a rectangular box structure housing the High Speed Power Transmission cable and the bogies, road with a middle trench carrying the High Speed Power transmission cable and electromagnetic coupling capability with the road vehicle and runways having a middle of the runway a trench to house the High Speed Power transmission cable, extending from one Gravity Power Tower to another, the said pathways generally in a horizontal plane; the said Gravity Power Towers with built in microprocessor based intelligence and inter communication among towers and rolling masses, the microprocessor intelligence controlling gear ratio and direction of the variable a gear system thus inter connecting the vertical motions of the said heavy power masses in the Gravity Power Tower and the rolling units, causing automatic transportation of rolling mass units attached to the power transmission cables traveling on the transport pathways, in such a manner that the vertically moving heavy masses called Power Masses, typically of the order of ten times that of the rolling mass unit, in the said Gravity Power Towers and the rolling mass units can run eternally, on the pathways, starting from one gravity Power Tower to stopping at another, practically almost entirely based on the gravity with the least input of external energy to cover friction losses in rolling and gears, constantly balancing the variation in potential energy of the set of masses in Gravity Power Tower with inverse variation of kinetic energy of set of the connected rolling masses, the rolling mass units drawing the needed tractive effort from the Power Masses in a controlled manner to accelerate away from a Gravity Power Tower, but the set of Power Masses gain back the lost potential energy by taking away the kinetic energy of other rolling mass units approaching the Gravity Power Tower, thus stopping the said approaching rolling mass units while raising back the said Power Masses; the shortfall in recovering the height lost of the Power masses because of frictional losses alone needs external energy, thus converting existing rail, road or runway in to an automated, practically perpetual and self-sustained linearly oscillating Gravity Powered transportation systems, once set off with a one time initial charge of potential energy of the sets of Heavy Power Masses, thus effectively saving a major portion of currently used energy in the transportation of people and goods.

2. The apparatus comprising of a set of networked Gravity Power Towers as in claim 1, each of the Gravity Power Tower as in claim 1, comprising of a number of Power Mass Modules, each Power Mass Module having an embodiment comprising of vertically moving very heavy mass of the order of hundreds of tonnes, the said large mass dropping vertically under acceleration due to gravity in a controlled manner, known as Power mass, to engage and drive gear system of a power transmission cable, to which the said rolling mass, typically less than a hundred tonnes, is coupled and provide the traction force to move a rolling mass of size a fraction of the power mass at a fraction of acceleration due to gravity in generally horizontal or graded direction, to reach desired maximum speed, sustain the speed as needed, but recover back most of the energy by raising the Power masses, which dropped while driving some other rolling masses in another linked gravity power tower, on some other pathways, thus conserving energy needed in transporting the rolling masses, thus needing only marginal incremental input of external energy to make up merely for the energy losses of rolling friction and gear friction, forming an integrated vertically oscillating heavy masses in consonance with horizontally oscillating rolling masses, constantly matching variation in potential energy of Power Mass with inverse variation in kinetic energy of rolling mass, with microprocessor based intelligence to control the coordination, becoming a self-perpetuating system once started, needing external energy input only to make up for friction losses, which appears as a shortfall in recovery of height lost by the Power mass, practically balancing the energy spent with energy recovered over a cycle of typically 24 hours, with short term imbalance of number of rolling mass units to be driven away taking energy being more than the number of rolling units with kinetic energy arriving at the Gravity Power Tower from which the energy is to be recovered, thus the Gravity Power Tower provides enough height for additional vertical travel for the Power masses, but this typically results in the Tower height of 15 to 20 m.

3. The Gravity Power Tower as in claim 1, comprising of Power Mass Module, which stores maximum energy of gravity in the form of potential energy when the supporting cables of the heavy mass is fully wound on the roller drum mounted on a shaft with gear connections to an electric motor as also to the main gear system and to a fly wheel energy storage unit, the said storage unit activated more for secondary storage of energy received from internal momentums gained by the very heavy Power masses which need to be stopped after their gear systems are disconnected from driving a rolling mass; this stored energy from flywheel is given back as needed, particularly when the heavy power mass at rest is given the initial upward movement, to be connected to the gear system of the power transmission cable though the main gear system, to be raised by the rolling mass moving at peak speed towards the said Gravity Power Tower; thus to avoid shock, the energy is drawn back from the flywheel storage to start the first slow upward movement, and further the variable gear system utilised to operate at high gear ratio to minimise relative velocity at the time of interconnection, and not for driving the rolling mass, the gear connections made as needed, by the combined working of the microprocessor based intelligence in the main gear system, the gear system of the High Speed Power transmission cable and the gear system connecting the flywheel storage.

4. The Gravity Power Tower as in claim 1, comprising of Power Mass Modules, which is capable of receiving kinetic energy from a rolling mass approaching in generally at horizontal direction, at a speed and needed to stop, the kinetic energy received though a Power Transmission Cable to which the speeding rolling mass is coupled, the said Power mass in the Power mass Module either one or more than one, get engaged though the main gear system to the gear system of the Power Transmission cable, and the said power mass or masses rise vertically against gravity thus gaining back potential energy while taking away the kinetic energy of the rolling mass, to bring the said rolling mass to a halt, thus recovering most of their original energy back, earlier used to drive similar rolling mass over another pathway, the timing and process controlled by microprocessor based intelligence.

5. The Gravity Power Tower as in claim 1, comprising of Power Mass Modules, in which the said heavy power mass can drive a rolling mass unit at a constant high acceleration even at very high speeds by the use of variable gear ratio, and gravitational force, unlike in case of electric motors which get limited in power delivery at higher rotor speeds and similarly braking does not depend on the adhesion of wheel and the pathway, so deceleration at a constant high value, commensurate with human comfort is possible, while the Power Mass recovers its potential energy getting hauled up by the rolling unit approaching the said Gravity Power Tower, thus losing its own kinetic energy and coming to stop, the entire process controlled intelligently by the microprocessors in the main gear system by manipulating the variable gear ratio, such that the rolling unit comes to a stop at a predetermined location, like an access point.

6. The Gravity Power Tower as in claim 1, comprising of Power Mass Modules, the said Power Mass Module comprises of an electric motor and a flywheel energy storage both of which can act though the gear connectors to the shaft over which the cable drum of the power mass is mounted, to cause the mass to be lifted to make up for the hysteresis losses, or in a very rare case even to fully restore back the power mass to its maximum potential energy or provide the just needed upward movement of the heavy power mass, before getting connected to the speeding rolling mass unit to be stopped from peak speed.

7. The Gravity Power Tower as in claim 1, comprising of main gear system, intelligent enough to connect to one or more Power Masses, work out and set the gear ratio for providing the optimum required gravity power from one or more than one Power Mass Modules, to a Power Transmission Cable gear to serve need of a rolling mass or recover kinetic energy from a stopping rolling mass, the gear ratio is gradually adjusted to practically eliminate internal shocks to make a smooth conversion of kinetic energy of rolling mass into gain of potential energy within the Power Mass Module, thus at any instant variation of potential energy of Power Masses always equals the variation of kinetic energy of the rolling mass attached to the Power transmission cable, after accounting for the loss of energy in internal rolling friction.

8. The Gravity Power Tower as in claim 1, comprising of the Power Transmission cable, which is an embodiment of continuously looping wire rope cable typically of a diameter of 15 to 20 mm, having pulley gear at one end connected to the main gear system of the Gravity Power Tower, the said pulley gear ratio controlled by the main gear system, and at the other end a pulley or again a pulley gear depending on the said other end not connecting, in another embodiment, or connecting with another gravity tower which is normal, to loop around and follows the guide way or path way that the rolling mass is using; the embodiment further has a double coned twin rollers, with a single flange at the thicker middle portion and the roller tapering from center to either end in a frame, the said frame of small size and the rollers traveling in the direction of motion of the cable, over twin steel rounds which are parallel to the Power Transmission Cable, the said steel rounds fixed on either side of an opening in a rectangular metal box typically of a size of 200 mm in width and 70 mm in height, and the entire frame with rollers contained in the said small metal box, with an arm from the frame extending out of the metal box though the said opening between the steel rounds, and the said arm coming out of the box firmly holding the Power Transmission cable, gives support and guidance for high speed travel, such said supporting frames occurring at intervals of typically 5 to 10 m, and all the support frames with the said special rollers, continuously travel in the metal box, and the metal box is continuous over the guide way that the Power Transmission cable serves, keeping the cable practically sag-free as well as fully guided and with low rolling friction, enabling high speed travel along with the rolling mass attached to it; the said metal box firmly fixed with the longer side not having the opening in middle, to one of the fixed elements of guide way or path way that the Power Transmission cable has to follow, the axis of the rectangular box running at middle of the pathway parallel, located in such a manner that the set of gripping arms of the rolling mass units can access. If the rolling mass is below the Power Transmission cable, then the weight of the cable is taken by the steel rounds fixed on either side of the opening; but in case the rolling mass is above the Power transmission cable, then additional pair of steel rounds are provided at bottom member to support the rollers of the frame and the rounds next to opening come into action when the Power Transmission cable gets coupled with the rolling mass, and cable gets lifted up, and the double coned wheel pair of the metal frame bogie, hug the steel round guides overhead.

9. The Gravity Power Tower as in claim 1, comprising of the embodiment of Power transmission cable which has a component of a set of gripping arms in scissors configuration, one end pair of which is mounted on the rolling mass permanently, and the other end pair get clamped or remain open depending on the operation of the end pair located on the rolling mass; further the inside of the grips which clamp on the Power Transmission cable have in built rollers perpendicular to cable, so that when being clamped with progressively increasing pressure first rollers will start rolling and as pressure increases the rollers get pressed inside and the grips firmly clamp on. This is to reduce friction and heat and to account for minor relative velocities between the cable and the rolling mass. In another embodiment the grips are replaced by an electromagnet operated by the rolling mass, and the Power transmission cable carries a steel plate at every frame support so that magnetic coupling is possible.

10. The apparatus comprising of a set of networked Gravity Power Towers as in claim 1, have Gravity Power controllers, comprising of microprocessors for processing information received from the main gear system controller, Power Transmission gear controller, the controllers on Power Mass Modules, the rolling mass controllers being handled by its Power transmission Cables; and while all most all local operational events of the tower are handled by the Main Gear System controller, the Gravity Power Controller supervises the same and also the Gravity Power Controller of the tower constantly interacts with colleague adjacent Gravity Power Controllers to know the status of arriving rolling masses and for planning and managing the energy levels to be maintained in the Power Mass Modules.

11. The apparatus comprising of a set of the networked Gravity Power Towers as in claim 1, linked with one or more than one other Gravity Power Towers, with pathways which, in one of the embodiments comprise of modified existing rail way, as a Gravity Powered Rail Module having a rectangular box enclosure made of steel or pre-stressed concrete, typically of a size of about 4 m in width and about 3 m in height in cross section, but of length equal to the route length, with a central running opening in the bottom member the opening parallel and running all along the route length, either above ground on column supports, or underground as part of a sub-way; the said box having two standard rails fixed on either side of the central opening at a standard gage, over which standard railway bogies with steel wheel axles run; in the present embodiment a space frame, an hour glass shaped in cross section, is placed in such a manner the top portion spans the bogies inside the said box enclosure, the narrow portion of the space frame occurring at the opening in the bottom member, with the bottom half of the space frame widening out to get firmly attached and integrated with a coach shell or a frame carrying a cargo container; thus coach shell out side the box enclosure and the supporting space frame spanning the bogies and riding with them, are structurally integrated with improved torsional resistance in horizontal plane, without any suspenders to hold the coach shell; the rolling mass, that is the coach with passengers or a container will not have any swing or sway even though traveling below the rail track and outside the box and below the box, as said mass is firmly part of the space frame riding over the running bogies in side the box; the said space frame is provided with gripping arms over each of the pair of running bogies, the said gripping arms clamp on to the Power Transmission Cables which traveling in its metal box enclosure as in claim 9, fixed overhead to the ceiling, gets either accelerated or retarded depending on the High Speed power transmission cable gear systems gets engaged with one or more than one Power Mass modules in the Gravity Power Tower to gain kinetic energy or lose as in claim 3, all these actions dictated by an intelligent microprocessor based on board controller in communication with Gravity Power Tower's microprocessor based controller; the said space frame with it's load will not load the High Speed power Transmission cable, but transfers the load on to the running bogies over which the space frame takes support; but as the space frame is pulled or retarded, the pair of bogies at either end get pulled along with the space frame through a pivot connection; thus the rolling mass in this embodiment becomes an integrated part of interacting masses within Gravity Power to become a self-sustained oscillating system taking and giving back energy whenever they travel from from one Gravity Power Tower to another but for friction losses; the top half of space frame inside the box and spanning the two running bogies, also contain within its confines firmly fixed a fly wheel energy storage unit, the said flywheel storage is not a primary energy provider, a battery pack, compressed air tank, and a compressed cold fresh air tank;

12. The apparatus comprising of a set of networked Gravity Power Towers as in claim 1, having in one of its embodiments of rail based modified pathways connected to other Gravity Power Towers, provided with the Gravity Powered Rail Module as in claim 11, further has an embodiment of four solid rubber wheels mounted on each of the rolling bogie frames, running on the rails in the rectangular enclosure, the said rubber wheels having axes of rotation perpendicular to track and they rotate in horizontal plane; the said rubber wheels normally do not touch the side walls though they travel very close to the side walls of the box enclosure; the said rubber tire wheels can run against the side walls, only when so engaged to feed energy to flywheel secondary energy storage, if needed, as the coaches get launched, but the said solid rubber tires mostly idle in travel thus not contributing to loss of energy in rolling friction; these rubber wheels do not guide the running space frame on bogies, the said bogies having standard steel wheel sets as in existing railways, guided only by rail track under, the rubber wheels having a short gap separating from the side walls of the box enclosure; the said rubber wheels serve as emergency derailment preventing system cum brakes for the bogies by stretching out to run against the side walls when a limiting lateral acceleration value of 0.35 g is reached, the said acceleration monitored by a microprocessor unit taking input from mounted accelerometers on the space frame and running bogies; thus the rubber tire butting laterally against the side walls will not allow the bogies to move laterally out of track; further the said solid rubber tire wheels also serve for emergency braking, when they get pushed to bear against the side walls and disc brakes applied to stop the motion using the friction between the rubber and the concrete surfaces, thus holding back the integrated space frame and the bogies connected; the said rubber tires when butt against the side walls, the reactions from each other get balanced in the horizontal direction, without adding to any vertical load nor any additional bending load to the space frame, which is the advantage of keeping the rubber wheels rotating around a vertical axis as compared to any other orientation of the axis of rotation; the wheel sets do not have any brake system nor any any electrical motors and gears, thus reducing internal friction as well as unsprung mass on rails.

13. The apparatus comprising of a set of networked Gravity Power Towers as in claim 1, with modified rail based pathway comprising of the Gravity Powered Rail Module as in claim 12, can be used in different embodiments as single, double or multiple formations, when one may have a double line route or multiple line route, in such a manner that the number of rolling mass units arriving at a Gravity Power Tower will generally be the same as those which need to be dispatched; all such modules integrated laterally with each other and supported by columns at he junctions; typically two of the Gravity Powered Rail Modules can be laterally attached to give a double line route, with a central hollow beam between the boxes being supported on columns rising from median of any road way in a city, the said columns being of such height that the bottom of the coach clears all road based traffic and access stations located also at that high level with lifts provided on side paths for commuters to board, and typically every station of access will have a gravity Power Tower located too. If need be the gravity Powered Module could be carried as bottom member of a cable stayed bridge to cross rivers or to provide long uninterrupted spanning in a city; the Gravity Power Towers in such cases may get located only at either end of such a bridge.

14. The apparatus comprising of a set of networked Gravity Power Towers as in claim 1, with modified rail based pathway comprising of the Gravity Powered Rail Module as in claim 12 and 13, in another embodiment, can be placed underground just below the existing road surface, the box enclosure of the module having its side walls extended below and resting and getting integrated with a bottom slab typically 7 to 8 m below ground level, providing water proof enclosure for the coach to travel under ground; sub-way access from foot paths and lifts to give access to coaches at stations going below the road level and located at side paths provide easy access for commuters; the Gravity Power Tower is also co-located underground to provide the gravity power and recover the power; further the modified rail based pathway run under gravity power, can have the same gradient as the roadway, because the tractive force is not dependent on the rail-wheel adhesion, thus giving significant advantage in sub-way construction costs.

15. The apparatus comprising of a set of networked Gravity Power Towers as in claim 1, in another embodiment of their connecting pathways comprising of modified existing road lanes in the city, carry in the middle of road along the alignment, a shallow continuous trench typically of width 400 mm and depth 200 mm to accommodate the metal box enclosure of the High Speed Power Transmission Cable as in claim 8 and 9; the said High Speed Power Transmission cables having firmly attached steel plates above the cable closer to road surface and parallel to road surface at every location of the frames having the pair of double coned single flange wheels running in the supporting and guiding metal enclosure, as in claim 8 and 9, the said trench top covered by a non-magnetic material without touching the traveling steel plates of the High Speed Power Transmission Cable; the said steel plates firmly attached to the High Speed Power transmission cable being capable of getting coupled with an electro-magnetic matching steel plate element of a road vehicle; the electro-magnetic steel plate, typically of 300 mm×300 mm size, fitted at the bottom of a road vehicle on an extended arm in the front such that the the said plate faces the road surface and travels close to the trench top but not touching the road surface, in the middle of the said modified road lane; the electromagnetic steel plate on the road vehicle gets magnetised at the throw of a switch from the driver of the road vehicle, which then magnetically gets coupled to the High Speed Power Transmission cable traveling unseen in the trench below the road surface at specified speed for the lane; different lanes having different prescribed speeds of traveling High Speed Power Transmission cables; thus providing the tractive force to the road vehicle from the Power Masses of the Gravity Power Towers for steady movement or even acceleration or deceleration for all the vehicles in the road lane so attached to the Power transmission cable; the mass of the road vehicles so attached form the rolling mass units acting in consonance with the Power Masses to create a linearly oscillating system where in partially energy given for driving is recovered back while stopping the road vehicles by the Power masses after accounting for the friction losses. Existing electric powered road vehicle is expected to be modified by providing the Gripping arm with electro magnetic coupling plates, which allows the road vehicle to draw motive force from the Gravity Powered Road lane for moving at different speeds by changing the lanes, as well as charge their battery packs using the Gravity Powered Road. On the same High Speed Power Transmission Cable many road vehicles per a lane get attached drawing tractive effort. In another embodiment, the Power transmission cable carrying multiple road vehicles in a city can be interlinked with road signals, so that the column of vehicles are automatically brought to halt, while recovering their kinetic energy back as gain potential energy of the Power Masses. In another embodiment, intercity highway lanes can be similarly Gravity Powered with Gravity Power Towers located typically every kilometer or half a kilometer, convening existing road lanes into Gravity Powered Roads, even to power trucks but rail based modified pathways will prove to be more efficient in energy saving because of low friction losses. Green gas emissions get controlled substantially in Gravity Powered Roads, removing all the internal combustion engines for very long haul cases too for passenger cars, making electric cars viable.

16. The apparatus comprising of a set of networked Gravity Power Towers as in claim 1, in another embodiment of their connecting pathways for air traffic, comprises of existing runways duly modified to place the High Speed Power transmission cables, either one or two, in the central region and along the runway alignment of the modified runway all along, in a hidden trench as in claim 15; and the Power Mass modules at Gravity Power Towers at both the ends interconnected by the runway may be engaged for providing the hauling force to make an aircraft reach take off speed; the said hauling force is applied though traveling steel pates attached to the High Speed Power Transmission Cable, get engaged magnetically with an electromagnetic matching sets of plates on the aircraft landing and take off gear equipped with an electromagnetic grip and activated as in claim 15, or in alternative embodiment, a slit running along the center line of runway could provide a wire rope based grip as in claim 9, to make the air craft reach take off speeds of 200 knots from whence the air craft engines can take over. Similarly while landing the air craft could engage with Power Transmission cables in similar fashion as afore mentioned, and recover the kinetic energy of the air craft to recoup energy of the Power Mass Modules in the Gravity tower. Thus the aircrafts taking off and other aircrafts landing at an airstrip pathway linking two Gravity Power Towers can form a self perpetuating oscillating system where in energy is taken from the Power masses while taking off, but recovered back while landing of another aircraft, except for friction losses, thus creating Gravity Powered runways. The fuel consumption at take off stage is significant and this saving coupled with energy recovery from landing aircraft, can substantially help conserve fossil fuel.
